(19) United States
(12) Patent Application Publication
(10) Pub. No.: US 2007/0097347 A1
(43) Pub. Date: May 3, 2007

(54) Method for forming a circuit pattern by using two photo-masks

(75) Inventor: Macoto Kozuma, Tao-Yuan (TW)

Correspondence Address: BIRCH STEWART KOLASCH & BIRCH, PO BOX 747, FALLS CHURCH, VA, 22040-0747, US

(73) Assignee: Toppan Chungwa Electronics Co., Ltd.

(21) Appl. No.: 11/260,149

(22) Filed: Oct. 28, 2005

(51) Int. Cl. G03B 27/32

(52) U.S. Cl. 355/77; 355/53

(57) ABSTRACT

A method for forming a circuit pattern using two photo-masks. The method includes a first photo-mask with a first extracted circuit pattern in x-direction polarization plane, and adds the grating pattern to unify the pitch condition. Then, the first grating pattern added to cover the y-direction polarization plane. Then, the reflected light is illuminated the first photo-mask to transfer the circuit pattern of the x-direction polarization plane on the wafer. Then, a second photo-mask has a first trimming pattern thereon, wherein the trimming pattern of the second photo-mask can remove the first grating pattern on the desired circuit pattern of the photo-resist layer during the first exposing process.

### BACKGROUND OF THE INVENTION

1. Field of the Invention

The present invention relates to an exposure method, and more particularly to a method for forming a circuit pattern by using two photo-masks.

2. Description of the Prior Art

A photolithographic process, win which a circuit pattern such as a semiconductor element is formed, generally employs a method of transferring a pattern formed on a reticle (mask) onto a substrate such as a semiconductor wafer. A photo-resist having photosensitive properties is applied to the surface of the substrate, and a circuit pattern is transferred to the photo-resist in accordance with an illumination light image, i.e., the shape of a transparent pattern of reticle. In a projection exposure apparatus (e.g., stepper), an image of the reticle pattern is focused/projected on the substrate (wafer) through a projection optical system.

In an apparatus of this type, illumination light is limited to an almost circuit (rectangular) shape centered on the optical axis of an illumination optical system within a plane of the illumination optical system (to referred as an illumination optical system pupil plane hereinafter) serving as a Fourier transform plane on a surface of a reticle on which a pattern exists, or within an adjacent plane, thus illuminating the reticle. For this reason, the illumination light is incident on the reticle at right angle. In addition, a circuit pattern is drawn on a reticle (a glass substrate constituting of quartz or the like) used in this apparatus. The circuit pattern is constituted by transmission portions (substrate bare surface portions), each having a transmittance of nearly 100% with respect to illumination light and light-shielding portions (consisting of chromium or the like), each having a transmittance of nearly 0%.

The illumination light radiated on the reticle is diffracted by the reticle pattern, and 0^{th}-order diffracted light component and ±1^{st}-order diffracted light components are generated by the pattern. These diffracted light components are focused by a projection optical system to form interference fringes, i.e., an image of the reticle pattern, on the wafer.

In the conventional photolithograph technology, the original pattern has a specified circuit pattern thereon. If we use the normal illumination to expose the original photo-mask, the part of the circuit pattern of the original photo-mask cannot be exposed to the photo-resist on the wafer. Thus, the resolution of the circuit pattern would be decreased.

### SUMMARY OF THE INVENTION

It is an object of this invention to provide a method for utilizing double exposure and polarized illumination lithography to obtain a pattern with a specified circuit pattern thereon.

It is another object of this invention is to provide a method for extracting the two direction polarization plane and adding the grating pattern to unify pitch condition.

It is still object of this invention to provide a method that utilizes the two masks prepares by the way of the CAD (computer-aided design) tools to form the desired circuit pattern on the two photo-masks respectively.

According to abovementioned objects, the present invention provides a method for double exposure and polarized illumination lithography that includes a first photo-mask with a first extracted circuit pattern in x-direction polarization plane, and adds the grating pattern to unify the pitch condition. Then, the first grating pattern added to cover the y-direction polarization plane. Then, the reflected light is illuminated the first photo-mask to transfer the circuit pattern of the x-direction polarization plane on the wafer. Then, a second photo-mask has a first trimming pattern thereon, wherein the trimming pattern of the second photo-mask can remove the first grating pattern on the desired circuit pattern of the photo-resist layer during the first exposing process.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view showing a schematic arrangement of a lithographic system in accordance with the method disclosed herein;

FIG. 2A is a view of showing a schematic of the first photo-mask with a first circuit pattern in x-direction polarization plane in accordance with the method disclosed herein;

FIG. 2B is a view of showing a schematic of the first circuit pattern in x direction polarization plane is projected through the photo-resist layer on the wafer in accordance with the method disclosed herein;

FIG. 2C is a view of showing a schematic of the second photo-mask with trimming pattern thereon in accordance with method disclosed herein;

FIG. 2D is a view of showing a schematic of the photo-mask layout in y-direction polarization plane on the wafer in accordance with the method disclosed herein;

FIG. 3A is a view of showing a schematic of the first photo-mask with a second circuit pattern in y-direction polarization plane in accordance with the method disclosed herein;

FIG. 3B is a view of showing a schematic of the second circuit pattern in y-direction polarization plane is projected through the photo-resist layer on the wafer in accordance with the method disclosed herein;

FIG. 3C is a view of showing a schematic of the second photo-mask with the second trimming pattern thereon in accordance with method disclosed herein;

FIG. 3D is a view of showing a schematic of the photo-mask layout in x-direction polarization plane on the wafer in accordance with the method disclosed herein;

FIG. 4A is a view of showing a schematic of the first photo-mask with a first circuit pattern in x-direction polarization plane in accordance with the method disclosed herein;

FIG. 4B is a view of showing a schematic of the first photo-mask with a first circuit pattern in x-direction polarization plane is projected through the photo-resist layer on the wafer in accordance with the method disclosed herein;

FIG. 4C is a view of showing a schematic of the second photo-mask with a second circuit pattern in y-direction polarization plane in accordance with the method disclosed herein;

FIG. 4D is a view of showing a schematic of the second circuit pattern in y-direction polarization plane is projected through the photo-resist layer on the wafer in accordance with the method disclosed herein;

FIG. 4E is a view of showing a schematic of the second photo-mask with a trimming pattern thereon in accordance with the method disclosed herein; and

FIG. 4F is a view of showing a schematic of desired circuit pattern in x-direction polarization plane and in y-direction polarization plane is projected through the photo-resist layer on the wafer in accordance with the method disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

In general, the original pattern has a specified circuit pattern thereon. If we use the normal illumination light source to expose the circuit pattern of the original photo-mask, the part of the circuit pattern of the original photo-mask cannot be exposed through the photo-resist on the wafer. Thus, the present invention extracts the circuit pattern of the original mask into X-direction polarization plane and Y-direction polarization plane respectively, and adds the grating pattern to unify the pitch condition. In addition, the present invention also adds the trimming pattern on the original photo-mask layout to keep the two extracted patterns and removes the grating pattern. In the present invention, the two photo-masks can prepare by way of the CAD (computer-aided design) tools to form the desired circuit pattern on the two photo-masks respectively.

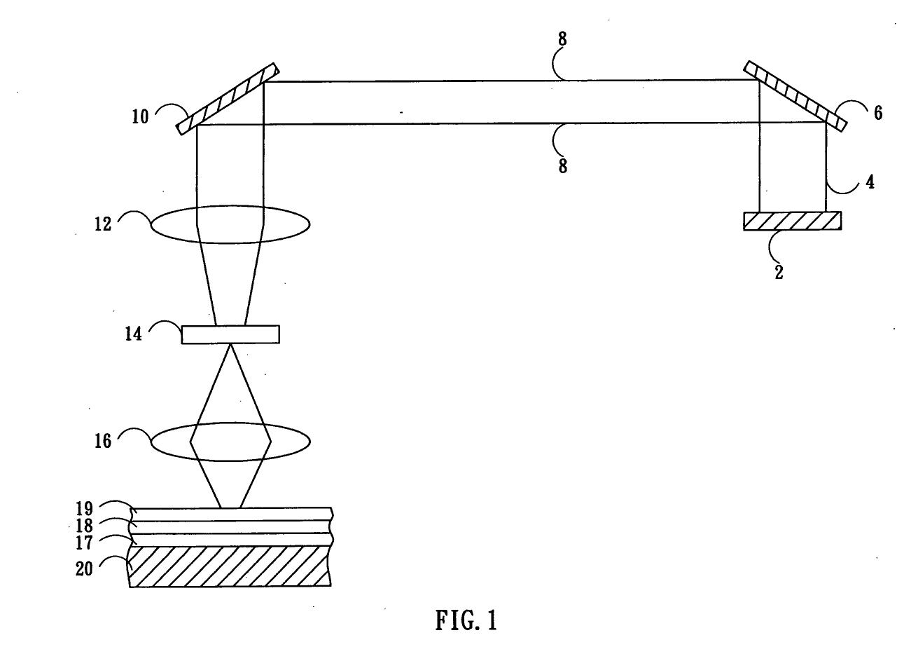

FIG. 1 is a view showing a schematic arrangement of a lithographic system according to an embodiment of the present invention. Referring to FIG. 1, a linear polarized illumination light 4 is generated by a light source 2 that is reflected by a first reflecting mirror 6, and the reflected light 8 is reflected to a second reflecting mirror 10 from the first reflecting mirror 6. The illumination light 4 is a laser beam with the specified energy, therefore, the intensity of the illumination light 4 can show by two directions, TE and TM. TE is an electric field direction which is parallel to the incident plane, and TM is a magnetic field which is perpendicular to the incident plane. The illumination light 4 can be KrF or ArF excimer laser, and the wavelength of the illumination light such as 193 nm, or 248 nm. Then, the illumination lens or condense lens 12 focused the reflected light 8 from the second reflecting mirror 10. Next, the reflected light 8 is projected the specified circuit pattern (not shown) on the photo-resist layer 18 which is on the wafer 20 through the projection lens 16, while the reflected light 8 passing through the photo-mask 14 with the specified circuit pattern thereon. The photo-resist layer 18 includes an absorbed spectrum material therein.

In the preferred embodiment of the present invention, the projection lens 16 has a higher numerical aperture (NA) to reduce the background light intensity when the different diffraction polarization planes are applied twice. The value of NA is setting not less than 0.85 which is preferable use for the exposure system.

The present invention utilizes two photo-masks to obtain the desired circuit pattern. First, a transparent glass is provided as the photo-mask, and the transparent glass is made of quartz. Then, an opaque pattern 30 is formed on the transparent glass, and the opaque pattern 22 is usually chrome (Cr), chrome-less mask, or phase shift mask. The opaque pattern 22 is a desired circuit pattern for the user requirement. In the present invention, the desired circuit pattern has two extracted direction polarization planes, which is x-direction polarization plane and y-direction polarization plane respectively.

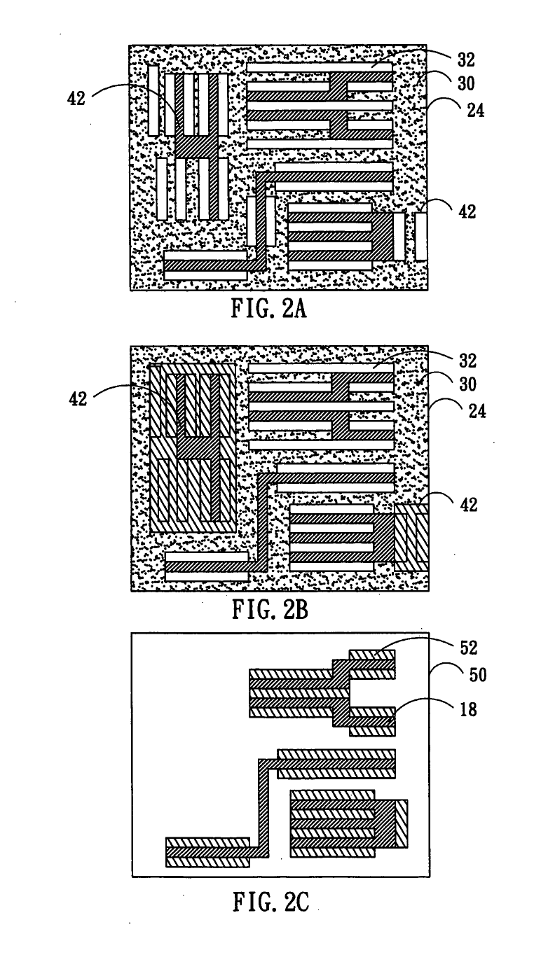

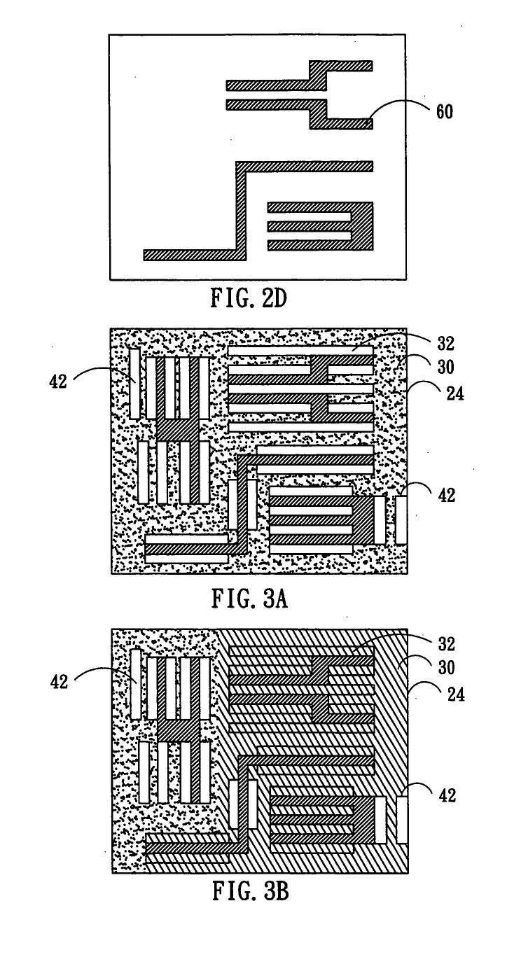

FIG. 2A is a view of showing a schematic of the first photo-mask with a first extracted circuit pattern in x-direction polarization plane. The preferred embodiment of the present invention uses the first photo-mask 24 with the first extracted circuit pattern in x-direction polarization plane, and adds the grating pattern to unify the pitch condition. Thus, in the first exposing process, the first grating pattern 42 added to cover the y-extracted direction polarization plane. In FIG. 2B shows the desired circuit pattern of x-direction polarization plane that is projected on the wafer. The reflected light is illuminated the first photo-mask 24 with the first extracted circuit pattern 32 in x-direction polarization plane through the projection lens to form the desired circuit pattern 32 of the x-direction polarization plane through the photo-resist on the wafer.

Then, referring to FIG. 2C, the second photo-mask 50 has a first trimming pattern 52 thereon to replace the first photo-mask 24 to place between the illumination lens and the projection lens (as shown in FIG. 1). The second photo-mask 50 adds to the original photo-mask layout to keep the first extracted circuit pattern. In addition, the first trimming pattern 52 of the second photo-mask 50 can remove the first grating pattern 42 on the desired circuit pattern of the photo-resist during the first exposing process. Thus, the circuit pattern layout 60 in x-direction polarization plane can be obtained on the wafer when the second exposing process is performed as shown in FIG. 2D.

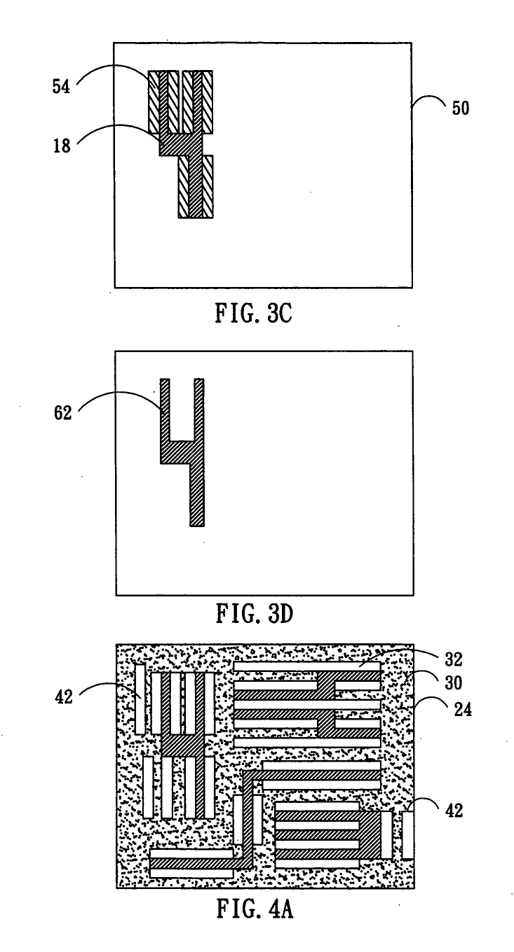

In alternative embodiment of the present invention, uses the first photo-mask with the second extracted circuit pattern in y-direction polarization plane, and adds the second grating pattern to unify the pitch condition. Referring to FIG. 3A, is a view of showing a schematic of the second photo-mask with two extracted circuit pattern in x-direction polarization plane and y-direction polarization plane respectively. In this embodiment, the second grating pattern 44 added to cover on the x-direction polarization plane. Thus, the reflected light is illuminated the second photo-mask 26 with the second extracted circuit pattern in y-direction polarization plane through the projection lens to form the circuit pattern 34 of the y-direction polarization plane through the photo-resist layer on the wafer as shown in FIG. 3B.

Then, referring to FIG. 3C, the second photo-mask 50 has a second trimming pattern 54 thereon to replace the first photo-mask 26 to place between the illumination lens and the projection lens. The second photo-mask 50 adds to the original photo-mask layout to keep the second extracted circuit pattern. In addition, the second trimming pattern 54 of the second photo-mask 50 can remove the second grating pattern 44 on the desired circuit pattern on the photo-resist layer during the second exposing process. As shown in FIG. 3D, the illumination light illuminated the second photo-mask to transfer the photo-mask layout on the wafer.

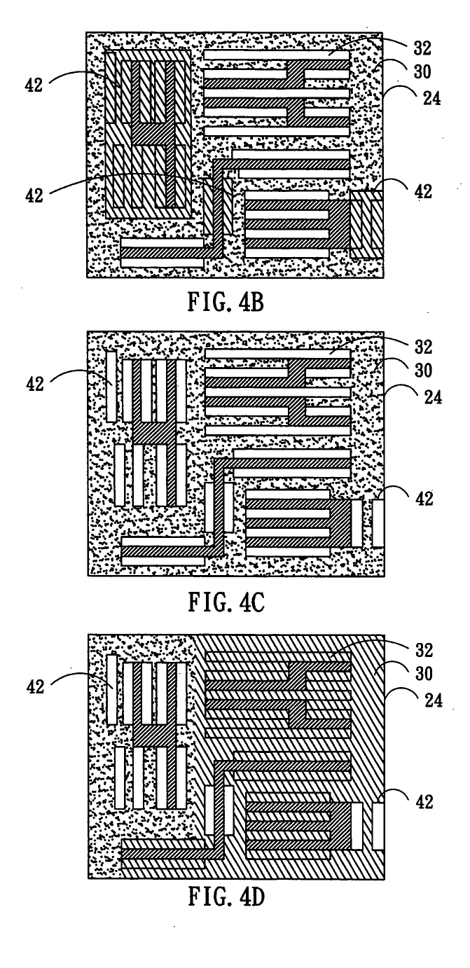

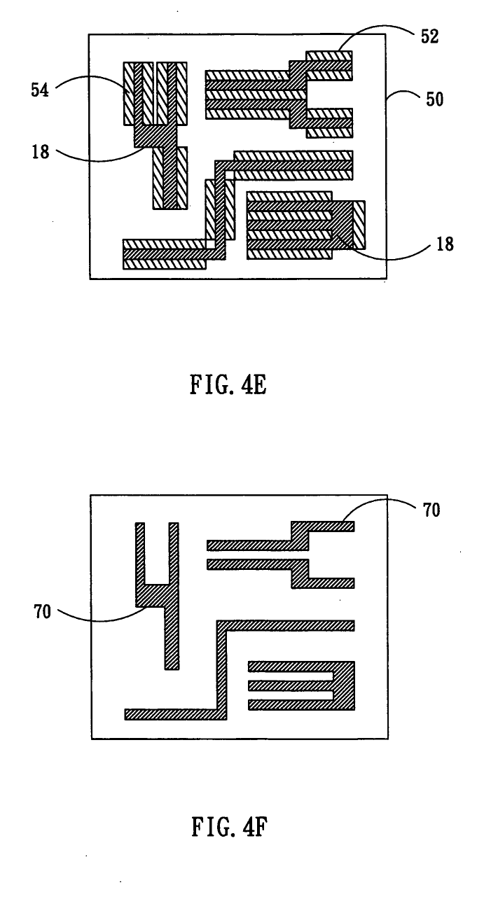

The present invention provides another preferred embodiment to obtain the fine circuit pattern on the wafer. FIG. 4A is a view of showing a schematic of the first photo-mask with a first circuit pattern in x-direction polarization plane. The further preferred embodiment of the present invention uses the first photo-mask 24 with the first circuit pattern 32 in x-direction polarization plane, and adds the first grating pattern 42 to unify the pitch condition. In the first exposing process, the first grating pattern 42 added to cover on the y-direction polarization plane. Thus, the reflected light is illuminated the first photo-mask 24 with the first circuit pattern 32 in x-direction polarization plane through the projection lens to form the first circuit pattern 32 of x-direction polarization plane through the photo-resist layer on the wafer during the first exposing process as shown in FIG. 4B.

Next, the second exposing process can be performed after the second grating pattern 44 is added to cover on the x-direction polarization plane. During the second exposing process, the overall conditions of the lithographic system and the first photo-mask are not to be changed. Referring to FIG. 4C, the second grating pattern 44 is added to cover on the x-direction polarization plane of the first photo-mask 24. Referring to FIG. 4D, the reflected light is illuminated the y-direction polarization plane of the first photo-mask 24 through the projection lens to form the pattern of y-direction polarization plane through the photo-resist layer on the wafer. Thus, the pattern of x-direction polarization plane and the pattern of y-direction polarization plane can be formed on the wafer by way of two exposing processes. It is noted that in order to reduce the background light intensity is to utilize a top coat which is coated on the photo-resist layer. The layer on the wafer includes an ARC film 17 that is formed on the wafer 20, a photo-resist layer 18 is formed on the ARC film 17, and a top coat layer 19 is formed on the photo-resist layer 18.

Then, referring to FIG. 4E, the second photo-mask 50 has a trimming pattern 52 thereon to replace the first photo-mask 24 to place between the illumination lens and the projection lens. Then, a third exposing process is performed to illuminate the trimming pattern 52 and to transfer the photo-resist layer of the wafer. The second photo-mask 50 adds to the original photo-mask layout to keep the first extracted pattern and the second extracted pattern. It is noted that the illumination of the first exposing process, second exposing process, and third exposing process is a linear polarized illumination light. In addition, the first trimming pattern 52 of the second photo-mask can remove the first grating pattern 42, and the second trimming pattern 54 can remove the second grating pattern 44 on the desired circuit pattern on the photo-resist layer during the first exposing process and the second exposing process. Therefore, the interaction between the x-direction polarization plane and the y-direction polarization plane can be reduced, and the resolution of the desired circuit pattern also can be increased. Thus, the desired circuit pattern in x-direction polarization plane and in y-direction polarization plane can be obtained on the wafer when the third exposing process is performed as shown in FIG. 4F.

Although specific embodiments have been illustrated and described, it will be obvious to those skilled in the art that various modifications may be made without departing from what is intended to be limited solely by the appended claims.

What is claimed is:

1. A method for a photolithography process with double exposure procedures, said method comprising:
providing a first photo-mask;
forming a desired circuit pattern on said first photo-mask;
adding a grating pattern to cover on said desired circuit pattern;
performing a first exposing process to illuminate said desired circuit pattern and to transfer said desired circuit pattern through a photo-resist layer on a wafer;
replacing said first photo-mask with a second photo-mask after said performing said first exposing process, wherein said second photo-mask with a trimming pattern; and
performing a second exposing process to transfer said trimming pattern through said photo-resist layer on said wafer, wherein said trimming pattern to keep said desired circuit pattern and to remove said grating pattern.

2. The method according to claim 1, wherein said first photo-mask is a transparent substrate which is made of quartz.

3. The method according to claim 1, wherein said grating pattern unified the pitch condition of said desired circuit pattern.

4. The method according to claim 1, wherein said performing said first exposure process and said second exposure process with using a linear polarized illumination light.

5. The method according to claim 4, wherein said linear polarized illumination light is selected from a group consisting of KrF and ArF excimer laser.

6. The method according to claim 1, wherein said desired circuit pattern has two extracted direction polarization planes, which is x-direction polarization plane and y-direction polarization plane respectively.

7. The method according to claim 1, further comprising a ARC film on said wafer, and said photo-resist layer is formed on said ARC film.

8. The method according to claim 1, wherein said photo-resist layer comprise an absorbed spectrum material.

9. The method according to claim 1, further comprising a top coat layer is formed on said photo-resist layer.

10. A method for forming a desired circuit pattern, the step of said method comprising:
(a) providing a first photo-mask;
(b) forming a desired circuit pattern has a first extracted direction polarization plane and a second extracted direction polarization plane on said first photo-mask;
(c) adding a first grating pattern to cover on said first extracted direction polarization plane of said desired circuit pattern;
(d) performing a first exposing process to illuminate said first extracted direction polarization plane of said desired circuit pattern and to transfer said first extracted desired circuit pattern through a photo-resist layer on a wafer;
(e) adding a second grating pattern to cover said second extracted direction polarization plane after said step (d);
(f) performing a second exposing process to illuminate said second extracted direction polarization plane of said desired circuit pattern and to transfer said second extracted desired circuit pattern on said photo-resist layer on said wafer;
(g) replace said first photo-mask with a second photo-mask, and said second photo-mask having a trimming pattern after said performing said second exposing process after said step (f); and
(h) performing a third exposing process to transfer said trimming pattern on said photo-resist layer on said wafer, wherein said trimming pattern to keep said desired circuit pattern that having said two extracted polarization direction planes and to remove said grating pattern.

11. The method according to claim 10, wherein said first photo-mask is a transparent substrate which is made of quartz.

12. The method according to claim 10, wherein said first grating pattern and said second grating pattern unified the pitch condition of said desired circuit pattern.

13. The method according to claim 10, wherein said performing said first exposure process, said second exposing process, and said third exposing process by using a linear polarized illumination light.

14. The method according to claim 10, wherein said linear polarized illumination light is selected a group consisting of KrF and ArF excimer laser.

15. The method according to claim 10, further comprising an ARC film on said wafer, and said photo-resist layer is formed on said ARC film.

16. The method according to claim 10, wherein said photo-resist layer comprises an absorbed spectrum material.

17. The method according to claim 10, further comprising a top coat layer is formed on said photo-resist layer.
